(19) United States
(12) Patent Application Publication
(10) Pub. No.: US 2026/0141014 A1
(43) Pub. Date: May 21, 2026

(54) SECURE CROSS SITE IDENTITY MAPPING

(71) Applicant: Zeta Global Corp., New York, NY (US)

(72) Inventors: Deepthi Venkitaramanan, Bolingbrook, IL (US); Viktor Dreiling, Rhauderfehn (DE); Ilia Petriaev, Berlin (DE); Niels Boldt, Bronshoj (DK)

(21) Appl. No.: 19/181,313

(22) Filed: Apr. 16, 2025

Related U.S. Application Data
(60) Provisional application No. 63/634,894, filed on Apr. 16, 2024.

(51) Int. Cl. G06F 16/958; H04L 9/40; H04L 51/21

(52) U.S. Cl. CPC G06F 16/958; H04L 63/0428; H04L 63/08; H04L 51/21

(57) ABSTRACT

The subject technology includes an identity mapping module that implements a system of networked communications that establish a consent based framework for creating and managing cross site identifiers across multiple publisher websites. The identity mapping module implements a call flow that coordinates multiple publisher sites with an authenticator website and an identity database to create a cross site identifier upon receiving a consent confirmation. The cross site identifier may be stored in local storage of a web client. One or more tags on the publisher website may communicate with the identity mapping module 106 to provide access to the cross site identifiers to enable other publisher websites with access to the authenticator website to quickly access the cross site identifier.

### PRIORITY CLAIM

This patent application claims the benefit of priority, under 35 U.S.C. Section 119(e), to Venkitaramanan et al, U.S. Provisional Patent Application Ser. No. 63/634,894 entitled “PATTERNS OF USAGE FOR CROSS SITE EMAIL BASED IDENTIFIER”, filed on Apr. 16, 2024 (Attorney Docket No. 4525.214PRV), which is hereby incorporated by reference in its entirety.

### TECHNICAL FIELD

The subject matter disclosed herein generally relates to networked communications for exchanging identity data, and more specifically, to the creation and exchange of identifiers across multiple online locations.

### BACKGROUND

Cookieless web clients including cookieless browsers (e.g., Safari browsers with Intelligent Tracking Prevention and Firefox browsers with Enhanced Tracking protection) block the setting and reading of third-party cookies by default disrupting the exchange of identifiers that publishers and advertisers rely on for efficient operation of online ad exchanges. Blocking third party cookies promotes more private online browsing experiences by prohibiting third parties from tracking user activity across multiple websites without consent. Preventing the exchange of third party cookies and other identifiers, however, also undermines the performance of digital ad exchanges that publishers and creators rely on for incentives to create and publish new content online. Additionally, blocking the flow of identity data makes online browsing less enjoyable and entertaining for users by reducing the relevance and quality of the creatives and experiences presented by brands to users online. An improved system of networked communications between browser clients, ad servers, publisher servers, and identity servers is needed to improve the scalability and performance of cookieless browsers. It is important that the networked communications system provide an consent based mechanism for exchanging identifiers across multiple websites in order to provide more secure and private browsing experiences while also improving the performance of online ad exchanges and ensuring better online experiences for users.

### BRIEF DESCRIPTION OF THE DRAWINGS

Some embodiments are illustrated by way of example and not limitation in the figures of the accompanying drawings.

FIG. 1 is a block diagram illustrating a high-level network architecture, according to various embodiments described herein.

FIG. 2 is a block diagram showing architectural aspects of an application server, according to various embodiments described herein.

FIG. 3 is a block diagram illustrating a representative software architecture, which may be used in conjunction with various hardware architectures herein described.

FIG. 4 is a block diagram illustrating components of a machine, according to some example embodiments, able to read instructions from a machine-readable medium (e.g., a machine-readable storage medium) and perform any one or more of the methodologies discussed herein.

FIG. 5 illustrates a call flow for generating a cross site identifier, according to various embodiments described herein.

FIG. 6 illustrates a process for accessing cross site identifiers by multiple publisher websites, according to various embodiments described herein.

### DETAILED DESCRIPTION

The description that follows includes systems, methods, techniques, instruction sequences, and computing machine program products that embody illustrative embodiments of the disclosure. In the following description, for the purposes of explanation, numerous specific details are set forth in order to provide an understanding of various embodiments of the inventive subject matter. It will be evident, however, to those skilled in the art, that embodiments of the inventive subject matter may be practiced without these specific details. In general, well-known instruction instances, protocols, structures, and techniques are not necessarily shown in detail.

Described herein is an identity mapping system for generating a cross site identifier. The identity mapping system may collect an indicia of consent (e.g., a click through on a pop up screen or other interaction with a UI element displayed within a web client) prior to generating a cross site identifier to enhance privacy by providing notice to users and confirming their consent before generating a cross site identifier. The identity mapping system may generate an authenticator site that sets a user identifier as a cross site identifier for the web client (e.g., a browser application running on a particular user device). The authenticator site may provide the cross site identifier to multiple publisher servers to enable publishers to build user profiles including cross domain activities. The identity mapping system may also establish a logged in network of publisher websites that may access the cross site identifier upon receiving consent from a web client. The identity mapping system may facilitate the exchange of identity data across the logged in network to improve the performance of online ad exchanges and deliver better online browsing experiences for users.

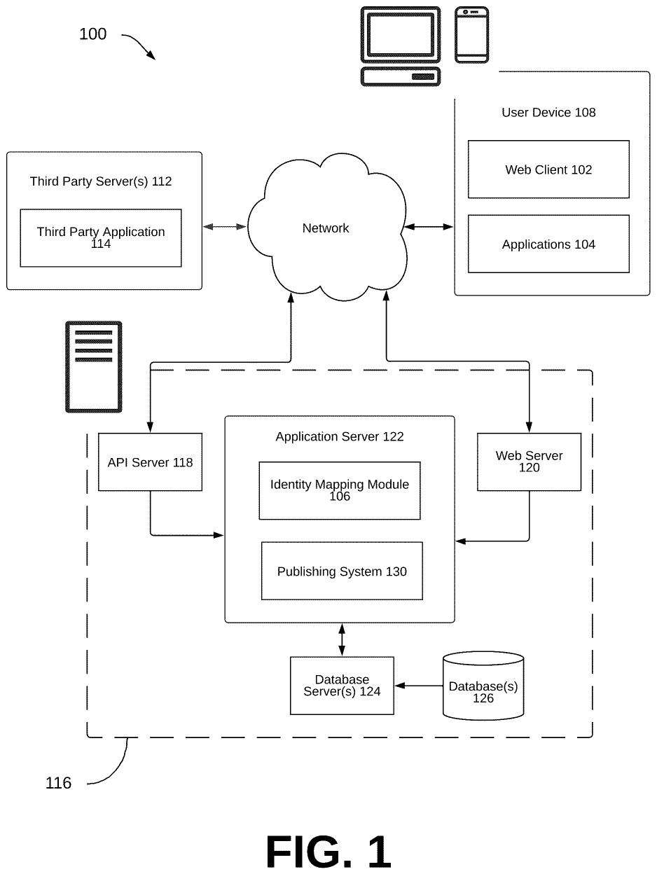

With reference to FIG. 1, an example embodiment of a high-level SaaS network architecture 100 is shown. A networked system 116 provides server-side functionality via a network 110 (e.g., the Internet or WAN) to a user device 108. A web client 102 (e.g., web browser, mobile app, API client, and the like) and a programmatic client, in the example form of a client application 104, are hosted and execute on the client device 108. The networked system 116 includes an application server 122, which in turn hosts an identity mapping 106 and a publishing system 130 that provide a number of functions and services to the client application 104 and/or web client that accesses the networked system 116. The client application 104 and/or application server also provides a number of graphical user interfaces (GUIs) described herein that may be displayed on one or more user devices 108 and may receive inputs thereto to configure an instance of the web client 102 and/or client application 104 and monitor operations performed by the application server 122. For example, the application server 122 may display a consent form as a pop up window in a web client 102 in order to collect a consent indica from a user device 108. The application server 122 may also display an authenticator site on the web client 102 to authenticate a user associated with the web client 102 and set a cross site identifier. The client application 104 may provide campaign setup user interfaces for selecting campaign configuration settings, a content personalization user interface for editing language model prompts, viewing generated content, and the like, a campaign monitoring user interface for tracking campaign performance, and the like which can present outputs to a user of the client device 108 and receive inputs thereto in accordance with the methods described herein.

The client device 108 enables a user to access and interact with the networked system 116 and, ultimately, the application server 122. For instance, the user provides input (e.g., touch screen input or alphanumeric input) to the client device 108, and the input is communicated to the application server 122 and other components of the networked system 116 via the network 110. In this instance, the networked system 116, in response to receiving the input from the user (e.g., a consent indica), communicates information back to the application server 122 via the network 110 to enable the identity mapping module 106 to configure the web client. Consent forms, and authentication sites generated by the identity mapping module may also be transmitted to the web client 102 for display on the user device 108 via the network 110 of the networked system 116.

An API server 118 and a web server 120 are coupled, and provide programmatic and web interfaces respectively, to the application server 122. The identity mapping module 106 hosted by the application server 122 may include components or applications described further below. The publishing system 130 hosted by the application server 112 may include an online exchange that executes dynamic auctions and other programmatic distribution mechanisms form publishing ad content to available inventory on publisher websites. The publishing system 130 may also include a message transfer agent (MTA), email service provider (ESP), email server, and other components that distribute email messages. The application server 122 is, in turn, shown to be coupled to a database server 124 that facilitates access to information storage repositories (e.g., a database 126). In an example embodiment, the database 126 includes identity data recorded and/or accessed by the identity mapping module. The database 126 may also include content and other information used by the publishing system to distribute content.

Additionally, a third-party application 114, executing on one or more third-party servers 112, is shown as having programmatic access to the networked system 116 via the programmatic interface provided by the API server 118. The third-party application 114 (e.g., a publisher website) may use information retrieved from the networked system 116 (e.g., a cross site identifier) to build user profiles and personalize experiences offered by the third party application 114.

Turning now specifically to the applications hosted by the client device 108, the web client 102 may access the various systems (e.g., the identity mapping module 106) via the web interface supported by the web server 120. Similarly, the client application 104 (e.g., a digital marketing platform) accesses the various services and functions provided by the identity mapping module 106 and publishing system 130 via the programmatic interface provided by the API server 118. The client application 104 may be, for example, an “app” executing on the client device 108, such as an iOS or Android OS application, to enable a user to access and input data on the networked system 116 in an offline manner and to perform batch-mode communications between the client application 104 and the networked system 116. The client application 104 may also be a web application or other software application executing on the client device 108.

Further, while the SaaS network architecture 100 shown in FIG. 1 employs a client-server architecture, the present inventive subject matter is of course not limited to such an architecture, and could equally well find application in a distributed, or peer-to-peer, architecture system, for example. The identity mapping module 106 and/or the publishing system 130 could also be implemented as standalone software programs, which do not necessarily have networking capabilities.

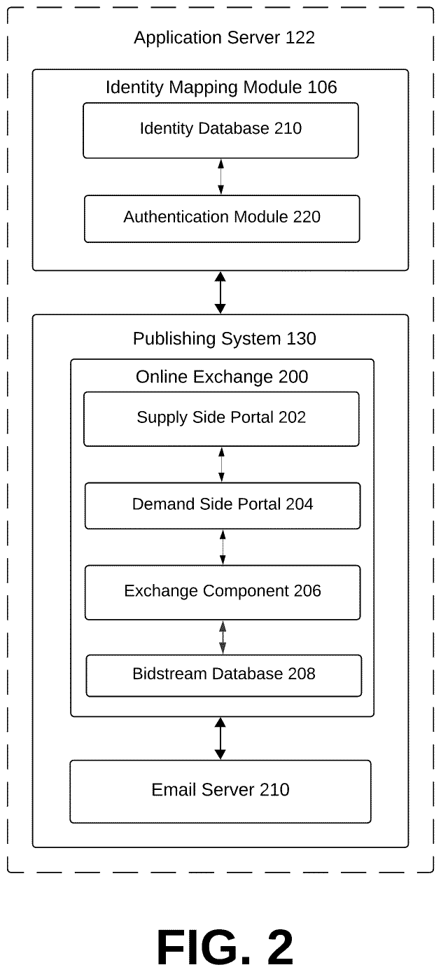

FIG. 2 is a block diagram showing architectural details of the application server 122, according to some example embodiments. Specifically, the application server 122 is shown to include an identity mapping module 106 and a publishing system 130. The application server 122 may include an interface component by which the identity mapping module 106 and publishing system 130 may communication with each other and communicate (e.g., over a network 110) with other systems within the SaaS network architecture 100.

The identity mapping module 106 may include an identity database 210 that may store identity data. The identity data may be stored in one or more identity graphs that include multiple nodes and edges connecting two or more nodes. Each node may represent a unique identifier and one or more consumer attributes associated with the unique identifier may be stored as node metadata. Consumer attributes may include one or more pieces of consumer data (e.g., location data, demographic data, device metadata, machine learned attributes, interest codes, and the like), event data (e.g., impressions and other engagement data, and the like) and transaction data (purchase records, purchase amounts, transaction metadata, and the like) associated with the target user. For example, one node may be a plain text email address (e.g., targetcustomer@gmail.com) and/or hashed email address (e.g., an email address that has been converted into a fixed-length string of characters using a hashing algorithm (e.g., SHA-256)). The identity attributes included as node metadata for the hashed email address may include event data listing timestamped records of emails sent to the email address and open and clickthrough events for the sent emails. Other node metadata may include transaction data listing timestamped purchase records for products ordered using the email address and consumer data listing a physical address, device ID or other identifier associated with the email address, interest codes that identity the subject of webpages accessed by the email address, and the like.

One or more machine learned insights may also be included as consumer attributes that are stored in node metadata. The machine learned insights may be determined using one or more machine learning models trained on data cloud data (e.g., consumer data, event data, transaction data, and the like) and one or more external datasets. The machine learned insights may include I-scores indicating a user's interest in a brand or likelihood to purchase a product and P-scores indicating a behavioral traits and other aspects of a user's personality. The I-scores may include brand propensity scores (e.g., a predicted likelihood a user will shop at store of a particular brand, purchase a particular brand of athletic shoes or other goods, view content published by a particular brand on one or more digital media channels, and the like), brand affinity scores (e.g., a predicted likelihood of how frequently and/or consistently users engage with particular brands, for example, how often users will purchase products made by the brand, click or view ads or emails sent by the brand, visit a particular brand website, and the like), product propensity scores (e.g., a predicted likelihood a user will buy or show interest in (e.g., view/click content related to) particular products or services), and the like. P-scores may include an attitude or behavioral propensity score (e.g., a predicted likelihood a user is materialistic, athletic, health conscious, frugal, aggressive, or other personality trait) or a channel propensity score (e.g., a predicted likelihood a user will engage with content on email, web page display, mobile display, connected tv, linear tv, gaming, social media, or other digital media channel).

The identity graphs may store identity data in identity clusters. Each identity cluster may include each of the raw and/or encrypted identifiers associated with common entity (e.g., device, user, household) as a node with an edge linking each node to a central node representing a unified id for the entity. The identity mapping module 106 may use the identity data in the identity database 210 to generate user profiles that include the identifiers represented by each node and the node metadata. As described in more detail below, the user profiles may be used by the publishing system 130 to improve the performance of the online exchange 200 and/or email server 210.

The identity mapping module 106 may also include an authentication module that may be used to generate a cross site id. The authentication module may place a id tag and an SSO tag on websites of one or more publishers. The tags may be a piece of code (e.g., JavaScript code) that is placed on a website. The tags collects data on the website and may interface with one or more other software components to provide additional functionality such as, identity resolution functionality. For example, a id tag may interface with the identity database 210 to sync one or more cookies associated with a website of a first publisher (e.g., one or more first party cookies) with other identifiers in the identity database 210 in order to resolve additional identifiers associated with the web client having the first party cookies. The id tag may also collect impression data that mappings the activity of a user on the website.

An SSO tag 113 may interface with an authentication website created by an authentication module 220 to set a cross site identifier. The SSO tag may also provide the cross site identifier to one or more publishers and/or provide access to a cross site id store based on receiving a consent confirmation from a publisher. The SSO tag may also reset the cross site identifier based on new impression events captured after the cross site identifier is set.

The publishing system 130 distribute content digitally over a network. For example, the publishing system may include an online exchange 200 that programmatically distributes ad content to available inventory on multiple publisher websites. The online exchange may include an online supply side portal 202 accessible to multiple third party servers (e.g., ad servers) of multiple publishers of content online. The supply side portal 202 may send bid requests to an exchange component 206 connected to a demand side portal 204. The bid request may be published by the exchange component in bidstream data that is logged in the bidstream database 208. The bid requests in the bidstream data may include identifiers and other information (e.g., placement size, ad format, website metadata (e.g., content tags, topic mappings, and the like), and/or device metadata (device identifiers, agent data, network data (e.g., IP address), geographic data, and the like) associated with an ad placement of a website. A demand side portal 204 accessible to one or more identity services providers and/or brands or other publishers of targeted content (e.g., ads) may read the bid requests in the bidstream data and place bids for available placements based on the identifiers and other data in the bid request. The exchange component 206 may process the bids using a dynamic auction or other distribution mechanism to execute a transaction that distributes ad placements.

The exchange component 206 may be communicatively coupled to the demand side portal 204 and the supply side portal 202 to present user interfaces enabling receipt of bids from a brand or other media provider for placement of content generated by the content engine 106 and other media by a publisher at a specified location or domain in available inventory on the publication network 110. In some examples, the publication system 130 may be configured to present media to a user at the specified location or domain on the publication network. The demand side portal 204 may be configured to reserve, upon the exchange component 206 resolving of a successful bid from the media provider, the specified location or domain for placement of media. The demand side portal 206 may then publish the piece of media at the reserved placements. The identity mapping module 106 may resolve a cross site identifier for one or more identifiers included in bid requests. The cross site identifier may be provided to one or more brands or other media providers connected to the demand side portal 204 to enable media providers to determine custom bid amounts for each bid request based on one or more user attributes (e.g., intender signals, impression events, conversation events, transaction histories, demographic data, geolocation data, and the like) included in a user profile associated with the cross site identifier. Accordingly, the publication system 130 and the identity mapping module 106 may work in concert to enable scalable digital media campaigns that include one-to-one personalized content for each of the users in the target audience of the campaign. Users accessing the locations including the reserved placements may view and engage with the media. In some examples, the publication system 130 is further configured to process a transaction between the media provider and the publisher based on the presentation or a viewing of the targeted media by the user, or a third party.

The publishing system 130 may also include an email server 210 that may distribute email messages to one or more email accounts associated with a cross site identifier provided by the identity mapping module 106. The email server may include an MTA, ESP, and other components required to send and receive email messages. A publisher may receive access to the cross site identifier from the identity mapping module 106 and configure the email content of one or more campaigns running on the email server 210 based on user attributes included in a profile associated with the cross site identifier. The email server 210 and the identity mapping module 106 may work in concert to enable scalable email campaigns that include one-to-one personalized content for each of the users in the target audience of the campaign. The email server 210 may be connected to the online exchange 200 in order to facilitate distributing ad placements in email messages through dynamic, real time auctions running on the online exchange 200.

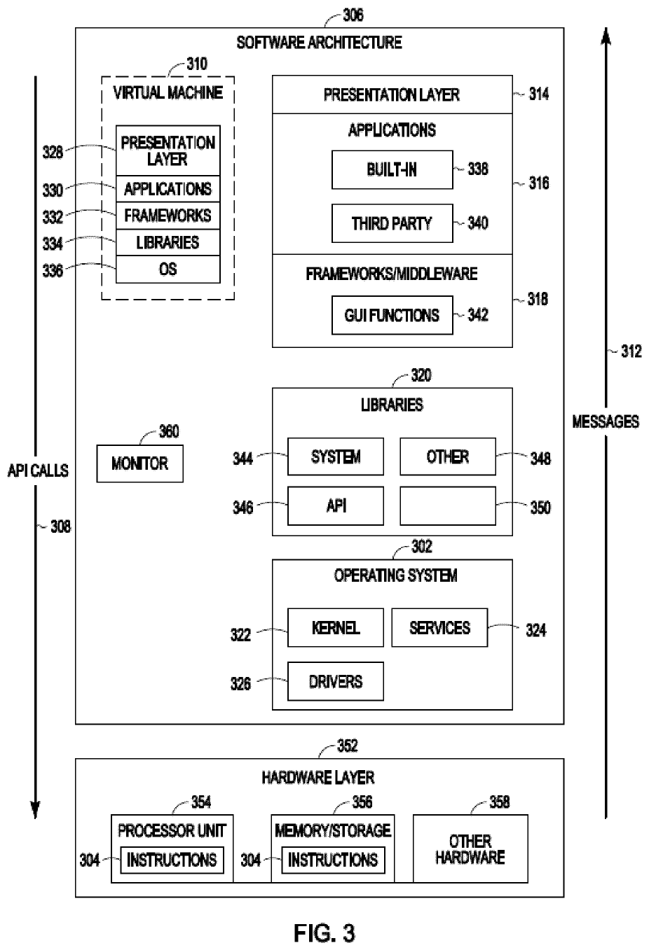

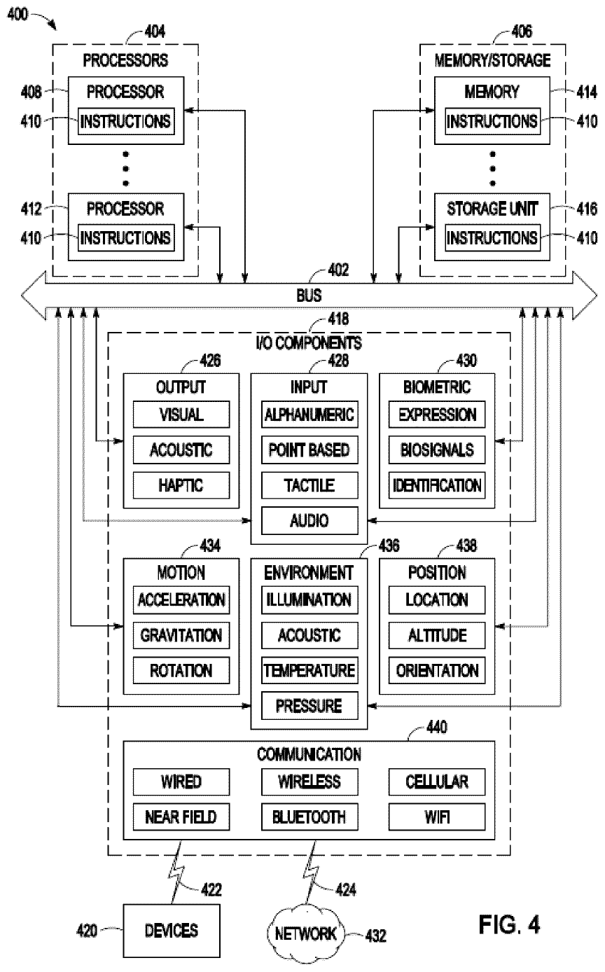

FIG. 3 is a block diagram illustrating an example software architecture 306, which may be used in conjunction with various hardware architectures herein described. FIG. 3 is a non-limiting example of a software architecture 306, and it will be appreciated that many other architectures may be implemented to facilitate the functionality described herein. The software architecture 306 may execute on hardware such as a machine 400 of FIG. 4 that includes, among other things, processors 404, memory/storage 406, and input/output (I/O) components 418. A representative hardware layer 352 is illustrated and can represent, for example, the machine 400 of FIG. 4. The representative hardware layer 352 includes a processor 354 having associated executable instructions 304. The executable instructions 304 represent the executable instructions of the software architecture 306, including implementation of the methods, components, and so forth described herein. The hardware layer 352 also includes memory and/or storage modules as memory/storage 356, which also have the executable instructions 304. The hardware layer 352 may also comprise other hardware 358.

In the example architecture of FIG. 3, the software architecture 306 may be conceptualized as a stack of layers where each layer provides particular functionality. For example, the software architecture 306 may include layers such as an operating system 302, libraries 320, frameworks/middleware 318, applications 316, and a presentation layer 314. Operationally, the applications 316 and/or other components within the layers may invoke API calls 308 through the software stack and receive a response as messages 312 in response to the API calls 308. The layers illustrated are representative in nature, and not all software architectures have all layers. For example, some mobile or special-purpose operating systems may not provide a frameworks/middleware 318, while others may provide such a layer. Other software architectures may include additional or different layers.

The operating system 302 may manage hardware resources and provide common services. The operating system 302 may include, for example, a kernel 322, services 324, and drivers 326. The kernel 322 may act as an abstraction layer between the hardware and the other software layers. For example, the kernel 322 may be responsible for memory management, processor management (e.g., scheduling), component management, networking, security settings, and so on. The services 324 may provide other common services for the other software layers. The drivers 326 are responsible for controlling or interfacing with the underlying hardware. For instance, the drivers 326 include display drivers, camera drivers, Bluetooth® drivers, flash memory drivers, serial communication drivers (e.g., Universal Serial Bus (USB) drivers), Wi-Fi® drivers, audio drivers, power management drivers, and so forth depending on the hardware configuration.

The libraries 320 provide a common infrastructure that is used by the applications 316 and/or other components and/or layers. The libraries 320 provide functionality that allows other software components to perform tasks in an easier fashion than by interfacing directly with the underlying operating system 302 functionality (e.g., kernel 322, services 324, and/or drivers 326). The libraries 320 may include system libraries 344 (e.g., C standard library) that may provide functions such as memory allocation functions, string manipulation functions, mathematical functions, and the like. In addition, the libraries 320 may include API libraries 346 such as media libraries (e.g., libraries to support presentation and manipulation of various media formats such as MPEG4, H.264, MP3, AAC, AMR, JPG, and PNG), graphics libraries (e.g., an OpenGL framework that may be used to render 2D and 3D graphic content on a display), database libraries (e.g., SQLite that may provide various relational database functions), web libraries (e.g., WebKit that may provide web browsing functionality), and the like. The libraries 320 may also include a wide variety of other libraries 348 to provide many other APIs to the applications 316 and other software components/modules.

The frameworks/middleware 318 provide a higher-level common infrastructure that may be used by the applications 316 and/or other software components/modules. For example, the frameworks/middleware 318 may provide various graphic user interface (GUI) functions 342, high-level resource management, high-level location services, and so forth. The frameworks/middleware 318 may provide a broad spectrum of other APIs that may be utilized by the applications 316 and/or other software components/modules, some of which may be specific to a particular operating system or platform.

The applications 316 include built-in applications 338 and/or third-party applications 340. Examples of representative built-in applications 338 may include, but are not limited to, a contacts application, a browser application, a book reader application, a location application, a media application, a messaging application, a publishing application, a content application, a campaign configuration application, performance monitoring application, a scoring application, and/or a game application. The third-party applications 340 may include any application developed using the ANDROID™ or IOS™ software development kit (SDK) by an entity other than the vendor of the particular platform and may be mobile software running on a mobile operating system such as IOS™, ANDROID™ WINDOWS® Phone, or other mobile operating systems. The third-party applications 340 may invoke the API calls 308 provided by the mobile operating system (such as the operating system 302) to facilitate functionality described herein.

The applications 316 may use built-in operating system functions (e.g., kernel 322, services 324, and/or drivers 326), libraries 320, and frameworks/middleware 318 to create user interfaces to interact with users of the system. Alternatively, or additionally, in some systems, interactions with a user may occur through a presentation layer, such as the presentation layer 314. In these systems, the application/component “logic” can be separated from the aspects of the application/component that interact with a user.

Some software architectures use virtual machines. In the example of FIG. 3, this is illustrated by a virtual machine 310. The virtual machine 310 creates a software environment where applications/components can execute as if they were executing on a hardware machine (such as the machine 400 of FIG. 4, for example). The virtual machine 310 is hosted by a host operating system (e.g., the operating system 302 in FIG. 3) and typically, although not always, has a virtual machine monitor 360, which manages the operation of the virtual machine 310 as well as the interface with the host operating system (e.g., the operating system 302). A software architecture executes within the virtual machine 310 such as an operating system (OS) 336, libraries 334, frameworks 332, applications 330, and/or a presentation layer 328. These layers of software architecture executing within the virtual machine 310 can be the same as corresponding layers previously described or may be different.

FIG. 4 is a block diagram illustrating components of a machine 400, according to some example embodiments, able to read instructions from a non-transitory machine-readable medium (e.g., a non-transitory machine-readable storage medium) and perform any one or more of the methodologies discussed herein. Specifically, FIG. 4 shows a diagrammatic representation of the machine 400 in the example form of a computer system, within which instructions 410 (e.g., software, a program, an application, an applet, an app, or other executable code) for causing the machine 400 to perform any one or more of the methodologies discussed herein may be executed. As such, the instructions 410 may be used to implement modules or components described herein. The instructions 410 transform the general, non-programmed machine 400 into a particular machine 400 programmed to carry out the described and illustrated functions in the manner described. In alternative embodiments, the machine 400 operates as a standalone device or may be coupled (e.g., networked) to other machines. In a networked deployment, the machine 400 may operate in the capacity of a server machine or a client machine in a server-client network environment, or as a peer machine in a peer-to-peer (or distributed) network environment. The machine 400 may comprise, but not be limited to, a server computer, a client computer, a personal computer (PC), a tablet computer, a laptop computer, a netbook, a set-top box (STB), a personal digital assistant (PDA), an entertainment media system, a cellular telephone, a smart phone, a mobile device, a wearable device (e.g., a smart watch), a smart home device (e.g., a smart appliance), other smart devices, a web appliance, a network router, a network switch, a network bridge, or any machine capable of executing the instructions 410, sequentially or otherwise, that specify actions to be taken by the machine 400. Further, while only a single machine 400 is illustrated, the term “machine” shall also be taken to include a collection of machines that individually or jointly execute the instructions 410 to perform any one or more of the methodologies discussed herein.

The machine 400 may include processors 404 (including processors 408 and 412), memory/storage 406, and I/O components 418, which may be configured to communicate with each other such as via a bus 402. The memory/storage 406 may include a memory 414, such as a main memory, or other memory storage, and a storage unit 416, both accessible to the processors 404 such as via the bus 402. The storage unit 416 and memory 414 store the instructions 410 embodying any one or more of the methodologies or functions described herein. The instructions 410 may also reside, completely or partially, within the memory 414, within the storage unit 416, within at least one of the processors 404 (e.g., within the processor's cache memory), or any suitable combination thereof, during execution thereof by the machine 400. Accordingly, the memory 414, the storage unit 416, and the memory of the processors 404 are examples of machine-readable media.

The I/O components 418 may include a wide variety of components to receive input, provide output, produce output, transmit information, exchange information, capture measurements, and so on. The specific I/O components 418 that are included in a particular machine will depend on the type of machine. For example, portable machines such as mobile phones will likely include a touch input device or other such input mechanisms, while a headless server machine will likely not include such a touch input device. It will be appreciated that the I/O components 418 may include many other components that are not shown in FIG. 4. The I/O components 418 are grouped according to functionality merely for simplifying the following discussion, and the grouping is in no way limiting. In various example embodiments, the I/O components 418 may include output components 426 and input components 428. The output components 426 may include visual components (e.g., a display such as a plasma display panel (PDP), a light-emitting diode (LED) display, a liquid crystal display (LCD), a projector, or a cathode ray tube (CRT)), acoustic components (e.g., speakers), haptic components (e.g., a vibratory motor, resistance mechanisms), other signal generators, and so forth. The input components 428 may include alphanumeric input components (e.g., a keyboard, a touch screen configured to receive alphanumeric input, a photo-optical keyboard, or other alphanumeric input components), point-based input components (e.g., a mouse, a touchpad, a trackball, a joystick, a motion sensor, or other pointing instruments), tactile input components (e.g., a physical button, a touch screen that provides location and/or force of touches or touch gestures, or other tactile input components), audio input components (e.g., a microphone), and the like.

In further example embodiments, the I/O components 418 may include biometric components 430, motion components 434, environment components 436, or position components 438, among a wide array of other components. For example, the biometric components 430 may include components to detect expressions (e.g., hand expressions, facial expressions, vocal expressions, body gestures, or eye tracking), measure biosignals (e.g., blood pressure, heart rate, body temperature, perspiration, or brain waves), identify a person (e.g., voice identification, retinal identification, facial identification, fingerprint identification, or electroencephalogram-based identification), and the like. The motion components 434 may include acceleration sensor components (e.g., accelerometer), gravitation sensor components, rotation sensor components (e.g., gyroscope), and so forth. The environment components 436 may include, for example, illumination sensor components (e.g., photometer), temperature sensor components (e.g., one or more thermometers that detect ambient temperature), humidity sensor components, pressure sensor components (e.g., barometer), acoustic sensor components (e.g., one or more microphones that detect background noise), proximity sensor components (e.g., infrared sensors that detect nearby objects), gas sensors (e.g., gas sensors to detect concentrations of hazardous gases for safety or to measure pollutants in the atmosphere), or other components that may provide indications, measurements, or signals corresponding to a surrounding physical environment. The position components 438 may include location sensor components (e.g., a Global Positioning System (GPS) receiver component), altitude sensor components (e.g., altimeters or barometers that detect air pressure from which altitude may be derived), orientation sensor components (e.g., magnetometers), and the like.

Communication may be implemented using a wide variety of technologies. The I/O components 418 may include communication components 440 operable to couple the machine 400 to a network 432 or devices 420 via a coupling 424 and a coupling 422, respectively. For example, the communication components 440 may include a network interface component or other suitable device to interface with the network 432. In further examples, the communication components 440 may include wired communication components, wireless communication components, cellular communication components, Near Field Communication (NFC) components, Bluetooth® components (e.g., Bluetooth® Low Energy), Wi-Fi® components, and other communication components to provide communication via other modalities. The devices 420 may be another machine or any of a wide variety of peripheral devices (e.g., a peripheral device coupled via a USB).

Moreover, the communication components 440 may detect identifiers or include components operable to detect identifiers. For example, the communication components 440 may include Radio Frequency Identification (RFID) tag reader components, NFC smart tag detection components, optical reader components (e.g., an optical sensor to detect one-dimensional bar codes such as Universal Product Code (UPC) bar code, multi-dimensional bar codes such as Quick Response (QR) code, Aztec code, Data Matrix, Dataglyph, MaxiCode, PDF417, Ultra Code, UCC RSS-2D bar code, and other optical codes), or acoustic detection components (e.g., microphones to identify tagged audio signals). In addition, a variety of information may be derived via the communication components 440, such as location via Internet Protocol (IP) geo-location, location via Wi-Fi® signal triangulation, location via detecting an NFC beacon signal that may indicate a particular location, and so forth.

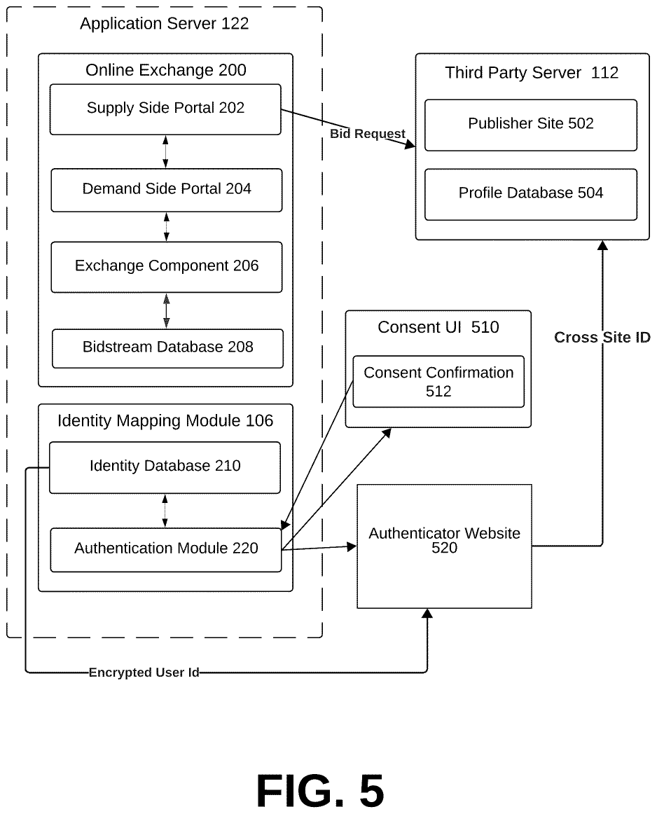

FIG. 5 illustrates a call flow for generating a cross site identifier. The call flow may include networked communications (e.g., server to server communications via the an Internet network) between the application server 122 and the third party server 112 that are used to create a cross site identifier and transmit the cross site identifier to the publisher site 502 (e.g., a website of a first publisher). The supply side portal 2 of the online exchange 210 may send a bid request to a third party server 112 (e.g., a publisher server). The bid request may be included in bidstream data published by an online exchange (e.g., the exchange component 230) and may include a first party identifier corresponding to a website of a first publisher (e.g., a publisher site 502). The first party identifier may be readable by only the first publisher and may be captured by a id tag on the publisher site 502.

The authentication module may generate a consent UI 510 that may collect a consent confirmation from a web client. The consent UI 510 may include a pop up UI element displayed on the publisher site. The consent UI 510 may include one or more UI elements for indicating user consent. For example, the consent UI may include a continue button and/or accept all button and/or check box that is clicked and/or selected by a user to indicate the user confirms he or she consents to login to the publisher site. The a single sign on (SSO) tag on the publisher website may cause the authentication module 220 to generate and display the consent UI on the publisher website.

The SSO tag may also configure one or more styling CSS elements of one or more UI elements in the consent UI to match the color, font, and style of one or more styling CSS elements of one or more UI elements on the publisher website. The identity mapping module 210 associate the consent confirmation with the first party identifier of the first publisher.

Upon receiving a consent confirmation, the authentication module 220 may generate an authenticator website 520. The third party server 112 may redirect the web client from the publisher site 502 to the authenticator website that is displayed in the web client. The authenticator website 520 may include a continue button that once selected authenticates the user and generates an encrypted user identifier for the web client. In various embodiments, the encrypted user identifier may be generated by collecting the first party identifier from a tag (e.g., an id tag, website tag, and the like) on the publisher site and passing the first party identifier to an identity graph included in the identity database. The identity database may be used to identify one or more identifiers (e.g., an encrypted email or other deterministic identifier for the web client) linked to the first party identifier. The identity database may select an encrypted user identifier (e.g., an encrypted email) from one or more linked identifiers. The authenticator website 520 may set the encrypted user identifier as the cross site identifier for the web client.

In various embodiments an id tag on the publisher site may obtain an encrypted email (or other encrypted user identifier) linked to the first party identifier from the identity database 210 directly. The third party server 112 may decrypt the encrypted user identifier by matching a decryption key in the bid request to a matching key in a key store on the third party server 112 to obtain a hashed identifier (e.g., an email hash) associated with the web client. The third party server may modify one or more aspects of an email message based on a user profile associated with the web client. The third party server may communicate with an email server included in the publishing system of the application server 122 to send the modified email message to an email address represented by the email hash.

The encrypted user identifier may also be generated by collecting the first party identifier from an id tag on the publisher site 502 and passing the first party identifier to the identity database 210. If the first party identifier is not associated with any other identifiers in an identity graph in the identity database 210, the identity database 210 will fail to resolve a user identifier for the first party identifier and will not return an encrypted user identifier. For web clients with no known deterministic identifiers, the authentication module may generate a random user identifier and encrypt the random user identifier and provide the encrypted user identifier as the encrypted user id. Regardless of how the encrypted user identifier is generated, the authentication module 220 may return the encrypted user identifier to the authenticator website 520. The encrypted user identifier is set by the authenticator website 520 as the cross site identifier for the web client. The authenticator website 520 may return the cross site identifier to the first publisher by recording the cross site identifier in a cross site id storage location of the web client.

The third party server 112 may use the cross site identifier used to create a user profile associated with the web client. Id tags on the publisher website may collect impression events, conversions, transactions, and the like and associate the collected events with the cross site identifier to build the user profile. The identity mapping module may read the cross site identifier in a cross site id store of the web client and add the cross site id and other user profile data to the identity database 210. In various embodiments, one or more aspects of the publisher site 502 may be modified based on the user profile data. For example, the third party server 112 may display a custom landing page on the publisher site 502 that welcomes a user associated with the web client having the cross site identifier. The third party server 112 may also populate one or more personalized product recommendations for the user associated with the web client having the cross site identifier.

In various embodiments, the authenticator website may reset the cross site id based on new impression activity collected by the id tag and/or SSO tag. To reset the cross site id by replacing the random encrypted user identifier with a user identifier deterministically linked to the web client (e.g., an encrypted email), an SSO tag may collect an impression activity for an email message delivered by an email server of the publishing system. The impression activity may be a click or other action that navigates the web client to the publisher site 502. The SSO tag, id tag, and/or identity mapping module 106 may use the identity database 210 may determine an encrypted user identifier associated with the impression activity (e.g., an encrypted email for the email account that originated the click). The encrypted user identifier may replace the random encrypted user identifier on the authenticator site 520 and the authenticator site 520 may reset the cross site identifier to the encrypted user identifier.

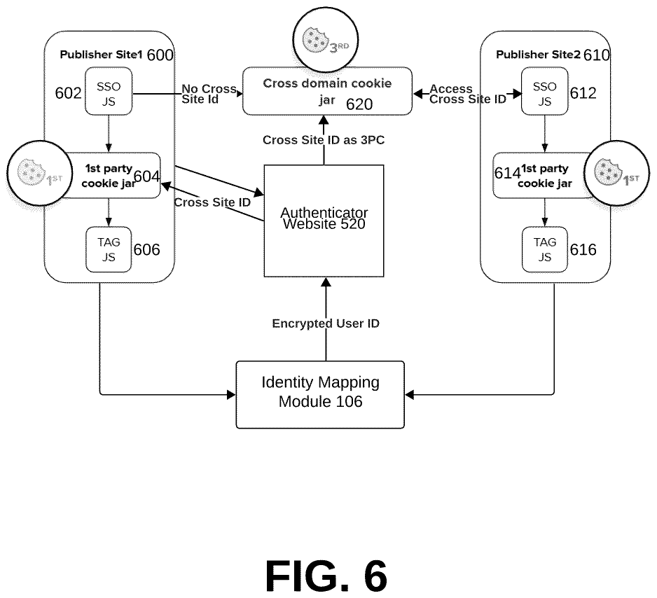

FIG. 6 illustrates a call flow for accessing cross site identifiers by multiple publisher websites. A cross site identifier may be generated by the SSO tag 602 on publisher site 1 600 using the call flow illustrated above in FIG. 5. The SSO tag 602 may generate the cross site identifier after checking the cross domain cookie jar 620 (e.g., the cross site id store) of the web client. The cross domain cookie jar 620 may be a storage location of the web client that stores identifiers that may be accessed by publishers that did not set the cookie. Access to the cross domain cookie jar 620 may be controlled by storage access application programming interface (API) that enforces rules for accessing the cross domain cookie jar 620 and reading the cross site identifiers stored in the cookie jar 620. For example, the storage access API may require a consent confirmation from a user of the web client before giving access to the cross domain cookie jar 620 to a publisher. The SSO tag 602 may obtain a consent confirmation using a consent UI displayed by the identity mapping module 106 on publisher site1 600. Upon obtaining consent the SSO tag may search the cross domain cookie jar 620 for a cross site id for the web client. If there is no cross site id in the cross domain cookie jar 620, the identity mapping module 106 may generate an authenticator site 520 that sets an encrypted user id from the identity mapping module 106 as the cross site id. The authenticator site 520 may store the cross site id in the first party cookie jar 604 of publisher site1 600. An id tag 606 may read the cross site identifier from the first party cookie jar 604 and resolve a user identifier (e.g., email hash) using the identity mapping module 106 which may provide a user identifier linked to the cross site identifier. The identity mapping module 106 may also decrypt the cross site identifier and provide the decrypted user id to the publisher for use in email retargeting and/or personalizing product recommendations provided on publisher site1 600.

In various embodiments, the cross site identifier may be provided to other publisher websites without requiring a redirect to the authenticator website 520. To provide the cross site identifier to publisher site2 610, an id tag on publisher site2 610 may collect a new first party identifier corresponding to publisher site2 610 (e.g., a webpage of a second publisher). A consent UI generated by an authentication module of the identity mapping module 106 may collect a consent confirmation from a web client at publisher site2 610. The consent confirmation may correspond to the new first party identifier. An SSO tag 612 on publisher site2 610 access the cross domain cookie jar 620 (e.g., the cross site id store) for the web client upon receiving the consent confirmation. The SSO tag 612 of publisher site2 610 may retrieve from, the cross domain cookie jar 620, the cross site identifier shared by the authenticator website 520, first party cookie jar 604 of publisher site1. The cross site identifier retrieved by the SSO tag 612 of publisher site2 610 may be stored in the first party cookie jar 614 of publisher site2. In various embodiments, the SSO tag 612 of publisher site2 610 may provide access to the cross domain cookie jar 620 by passing the consent confirmation in a call of a storage access API used by the web client to control access to the cross site identifier.

The publisher of publisher site1 and the publisher of publisher site2 may use the cross site identifier to build a user profile for a user associated with the web client. The user profile may map the first party identifier to the cross site identifier. The mapping may associate one or more user attributes linked to the first party identifier with the cross site identifier. To build a user profile, an identity tag 606, 616 of publisher site1 and publisher site2 may pass the cross site identifier to an identity graph to obtain one or more user attributes included in an identity cluster including one or more identifiers linked to the cross site identifier.

In this disclosure, the following definitions may apply in context. A “Client Device” or “Electronic Device” refers to any machine that interfaces to a communications network to obtain resources from one or more server systems or other client devices. A client device may be, but is not limited to, a mobile phone, desktop computer, laptop, portable digital assistant (PDA), smart phone, tablet, ultra-book, netbook, laptop, multi-processor system, microprocessor-based or programmable consumer electronic system, game console, set-top box, or any other communication device that a user may use to access a network.

“Communications Network” refers to one or more portions of a network that may be an ad hoc network, an intranet, an extranet, a virtual private network (VPN), a local area network (LAN), a wireless LAN (WLAN), a wide area network (WAN), a wireless WAN (WWAN), a metropolitan area network (MAN), the Internet, a portion of the Internet, a portion of the Public Switched Telephone Network (PSTN), a plain old telephone service (POTS) network, a cellular telephone network, a wireless network, a Wi-Fi® network, another type of network, or a combination of two or more such networks. For example, a network or a portion of a network may include a wireless or cellular network, and coupling may be a Code Division Multiple Access (CDMA) connection, a Global System for Mobile communications (GSM) connection, or another type of cellular or wireless coupling. In this example, the coupling may implement any of a variety of types of data transfer technology, such as Single Carrier Radio Transmission Technology (1xRTT), Evolution-Data Optimized (EVDO) technology, General Packet Radio Service (GPRS) technology, Enhanced Data rates for GSM Evolution (EDGE) technology, third Generation Partnership Project (3GPP) including 3G, fourth generation wireless (4G) networks, Universal Mobile Telecommunications System (UMTS), High-Speed Packet Access (HSPA), Worldwide Interoperability for Microwave Access (WiMAX), Long-Term Evolution (LTE) standard, others defined by various standard-setting organizations, other long-range protocols, or other data transfer technology.

“Component” (also referred to as a “module”) refers to a device, physical entity, or logic having boundaries defined by function or subroutine calls, branch points, application programming interfaces (APIs), or other technologies that provide for the partitioning or modularization of particular processing or control functions. Components may be combined via their interfaces with other components to carry out a machine process. A component may be a packaged functional hardware unit designed for use with other components and a part of a program that usually performs a particular function of related functions. Components may constitute either software components (e.g., code embodied on a machine-readable medium) or hardware components.

A “hardware component” is a tangible unit capable of performing certain operations and may be configured or arranged in a certain physical manner. In various example embodiments, one or more computer systems (e.g., a standalone computer system, a client computer system, or a server computer system) or one or more hardware components of a computer system (e.g., a processor or a group of processors) may be configured by software (e.g., an application or application portion) as a hardware component that operates to perform certain operations as described herein. A hardware component may also be implemented mechanically, electronically, or any suitable combination thereof. For example, a hardware component may include dedicated circuitry or logic that is permanently configured to perform certain operations. A hardware component may be a special-purpose processor, such as a field-programmable gate array (FPGA) or an application-specific integrated circuit (ASIC). A hardware component may also include programmable logic or circuitry that is temporarily configured by software to perform certain operations. For example, a hardware component may include software executed by a general-purpose processor or other programmable processor. Once configured by such software, hardware components become specific machines (or specific components of a machine) uniquely tailored to perform the configured functions and are no longer general-purpose processors.

It will be appreciated that the decision to implement a hardware component mechanically, in dedicated and permanently configured circuitry, or in temporarily configured circuitry (e.g., configured by software) may be driven by cost and time considerations. Accordingly, the phrase “hardware component” (or “hardware-implemented component”) should be understood to encompass a tangible entity, be that an entity that is physically constructed, permanently configured (e.g., hardwired), or temporarily configured (e.g., programmed) to operate in a certain manner or to perform certain operations described herein. Considering embodiments in which hardware components are temporarily configured (e.g., programmed), each of the hardware components need not be configured or instantiated at any one instant in time. For example, where a hardware component includes a general-purpose processor configured by software to become a special-purpose processor, the general-purpose processor may be configured as respectively different special-purpose processors (e.g., comprising different hardware components) at different times. Software accordingly configures a particular processor or processors, for example, to constitute a particular hardware component at one instant of time and to constitute a different hardware component at a different instant of time. Hardware components can provide information to, and receive information from, other hardware components. Accordingly, the described hardware components may be regarded as being communicatively coupled. Where multiple hardware components exist contemporaneously, communications may be achieved through signal transmission (e.g., over appropriate circuits and buses) between or among two or more of the hardware components. In embodiments in which multiple hardware components are configured or instantiated at different times, communications between such hardware components may be achieved, for example, through the storage and retrieval of information in memory structures to which the multiple hardware components have access. For example, one hardware component may perform an operation and store the output of that operation in a memory device to which it is communicatively coupled. A further hardware component may then, at a later time, access the memory device to retrieve and process the stored output. Hardware components may also initiate communications with input or output devices, and can operate on a resource (e.g., a collection of information).

The various operations of example methods described herein may be performed, at least partially, by one or more processors that are temporarily configured (e.g., by software) or permanently configured to perform the relevant operations. Whether temporarily or permanently configured, such processors may constitute processor-implemented components that operate to perform one or more operations or functions described herein. As used herein, “processor-implemented component” refers to a hardware component implemented using one or more processors. Similarly, the methods described herein may be at least partially processor-implemented, with a particular processor or processors being an example of hardware. For example, at least some of the operations of a method may be performed by one or more processors or processor-implemented components. Moreover, the one or more processors may also operate to support performance of the relevant operations in a “cloud computing” environment or as a “software as a service” (SaaS). For example, at least some of the operations may be performed by a group of computers (as examples of machines including processors), with these operations being accessible via a network (e.g., the Internet) and via one or more appropriate interfaces (e.g., an API). The performance of certain of the operations may be distributed among the processors, not only residing within a single machine, but deployed across a number of machines. In some example embodiments, the processors or processor-implemented components may be located in a single geographic location (e.g., within a home environment, an office environment, or a server farm). In other example embodiments, the processors or processor-implemented components may be distributed across a number of geographic locations.

“Image data” in this context refers to any type of visual media or other data that includes a number of rows and columns or pixels including, for example, images, frames of video, three dimensional holograms, pixel data, virtual reality (VR) content, augmented reality (AR) content, mixed reality (MR) content, extended reality (XR) content, and the like.

“Machine-Readable Medium” in this context refers to a component, device, or other tangible medium able to store instructions and data temporarily or permanently and may include, but not be limited to, random-access memory (RAM), read-only memory (ROM), buffer memory, flash memory, optical media, magnetic media, cache memory, other types of storage (e.g., Erasable Programmable Read-Only Memory (EPROM)), and/or any suitable combination thereof. The term “machine-readable medium” should be taken to include a single medium or multiple media (e.g., a centralized or distributed database, or associated caches and servers) able to store instructions. The term “machine-readable medium” shall also be taken to include any medium, or combination of multiple media, that is capable of storing instructions (e.g., code) for execution by a machine, such that the instructions, when executed by one or more processors of the machine, cause the machine to perform any one or more of the methodologies described herein. Accordingly, a “machine-readable medium” refers to a single storage apparatus or device, as well as “cloud-based” storage systems or storage networks that include multiple storage apparatus or devices. The term “machine-readable medium” excludes signals per se.

“Processor” refers to any circuit or virtual circuit (a physical circuit emulated by logic executing on an actual processor) that manipulates data values according to control signals (e.g., “commands,” “op codes,” “machine code,” etc.) and which produces corresponding output signals that are applied to operate a machine. A processor may, for example, be a Central Processing Unit (CPU), a Reduced Instruction Set Computing (RISC) processor, a Complex Instruction Set Computing (CISC) processor, a Graphics Processing Unit (GPU), a Digital Signal Processor (DSP), an ASIC, a Radio-Frequency Integrated Circuit (RFIC), or any combination thereof. A processor may further be a multi-core processor having two or more independent processors (sometimes referred to as “cores”) that may execute instructions contemporaneously.

A portion of the disclosure of this patent document may contain material that is subject to copyright protection. The copyright owner has no objection to the facsimile reproduction by anyone of the patent document or the patent disclosure, as it appears in the Patent and Trademark Office patent files or records, but otherwise reserves all copyright rights whatsoever.

Although the subject matter has been described with reference to specific example embodiments, it will be evident that various modifications and changes may be made to these embodiments without departing from the broader spirit and scope of the disclosed subject matter. Accordingly, the specification and drawings are to be regarded in an illustrative rather than a restrictive sense. The accompanying drawings that form a part hereof show by way of illustration, and not of limitation, specific embodiments in which the subject matter may be practiced. The embodiments illustrated are described in sufficient detail to enable those skilled in the art to practice the teachings disclosed herein. Other embodiments may be utilized and derived therefrom, such that structural and logical substitutions and changes may be made without departing from the scope of this disclosure. This Description, therefore, is not to be taken in a limiting sense, and the scope of various embodiments is defined only by any appended claims, along with the full range of equivalents to which such claims are entitled.

Such embodiments of the inventive subject matter may be referred to herein, individually and/or collectively, by the term “invention” merely for convenience and without intending to voluntarily limit the scope of this application to any single invention or inventive concept if more than one is in fact disclosed. Thus, although specific embodiments have been illustrated and described herein, it should be appreciated that any arrangement calculated to achieve the same purpose may be substituted for the specific embodiments shown. This disclosure is intended to cover any and all adaptations or variations of various embodiments. Combinations of the above embodiments, and other embodiments not specifically described herein, will be apparent to those of skill in the art upon reviewing the above description.

What is claimed is:

1. A system comprising:
one or more processors; and
a memory storing instructions that, when executed by at least one processor in the one or more processors, cause the at least one processor to perform operations for exchanging identity data in a cookieless environment, the operations comprising:
sending, in a bid request included in bidstream data published by an online exchange, a first party identifier corresponding to a website of a first publisher, wherein the first party identifier is readable by only the first publisher;
collecting at the website a consent confirmation from a web client, the consent confirmation corresponding to the first party identifier;
displaying an authentication website viewable in the web client, the authentication website generating an encrypted user identifier for the web client;
setting, by the authentication website, the encrypted user identifier as the cross site identifier for the web client;
returning the cross site identifier to the first publisher by recording the cross site identifier in a cross site id storage location of the web client, the cross site identifier used to create a user profile associated with the web client; and
reading the cross site identifier in a cross site id store of the web client.

2. The system of claim 1, wherein the encrypted user identifier is generated by collecting the first party identifier from a tag on the website of the first publisher;
passing the first party identifier to an identity graph including one or more identifiers linked to the first party identifier; and
selecting the encrypted user identifier from the one or more linked identifiers.

3. The system of claim 2, wherein the operations further comprise decrypting the encrypted user identifier to resolve an email hash associated with the web client;
modifying one or more aspects of an email message based on the user profile; and
sending, using an email server, the modified email message to an email address represented by the email hash.

4. The system of claim 1, wherein the encrypted user identifier is generated by collecting the first party identifier from a tag on the website of the first publisher;
passing the first party identifier to an identity graph;
failing to resolve a user identifier for the first party identifier using the identity graph;
encrypting a random user identifier; and
providing the encrypted random user identifier as the encrypted user identifier.

5. The system of claim 1, wherein the operations further comprise, collecting by an SSO tag, an impression activity for an email message delivered by an email server, the impression activity navigating the web client to the website associated with the first publisher;
determining an encrypted user identifier associated with the impression activity; and
replacing, on the authenticator site, the random user identifier with the encrypted user identifier; and
resetting the cross site identifier to the encrypted user identifier.

6. The system of claim 1, wherein the operations further comprise modifying one or more aspects of the website of the first publisher based on the profile.

7. The system of claim 1, wherein the operations further comprise, collecting, using a tag on a webpage of a second publisher, a new first party identifier corresponding to the webpage of a second publisher;
collecting at the website a consent confirmation from a web client, the consent confirmation corresponding to the new first party identifier;
accessing, using an SSO tag on the webpage of the second publisher, the cross site id store of the web client; and
retrieving, from the cross site id store, the cross site identifier.

8. The system of claim 6, wherein the SSO tag provides access to the cross site id store by passing the consent confirmation in a call of a storage access API used by the web client to control access to the cross site identifier.

9. The system of claim 1, further comprising, passing the cross site identifier to an identity graph to obtain one or more user attributes included in an identity cluster including one or more identifiers linked to the cross site identifier.

10. The system of claim 1, wherein the user profile maps the first party identifier to the cross site identifier, the mapping associating one or more user attributes linked to the first party identifier with the cross site identifier.

11. The system of claim 1, wherein the operations further comprise, causing, by an SSO tag on the website, a displaying of a pop up UI element on the website, the pop up window including a UI element for inputting the consent indica.

12. The system of claim 11, wherein the SSO tag configures one or more styling CSS elements of one or more UI elements in the popup UI element to match the color, font, and style of one or more styling CSS elements of one or more UI elements on the website.
